(19) United States
(12) Patent Application Publication
(10) Pub. No.: US 2009/0288042 A1
(43) Pub. Date: Nov. 19, 2009

(54) METHOD AND SYSTEM FOR CONTROLLING MULTIPLE COMPUTERS

(75) Inventor: Ching-Wei Cheng, Keelung (TW)

Correspondence Address: ROGER H. CHU, 19499 ERIC DRIVE, SARATOGA, CA, 95070, US

(73) Assignee: ACTION STAR ENTERPRISE CO., LTD., Sijhih (TW)

(21) Appl. No.: 12/123,153

(22) Filed: May 19, 2008

(51) Int. Cl. G06F 3/048

(52) U.S. Cl. 715/856

(57) ABSTRACT

A system for controlling multiple computers comprises a plurality of host computers with associated display screens with particular display boundaries, a set of a cursor control device and a keyboard and a KM (keyboard/mouse) switching device with second set ports coupled to each of the host computers and first set ports coupled to the cursor control device and the keyboard, wherein a pointer controlled by the cursor control device is located within one of the display screens with a particular display boundary and the host computer associated with the display screen is controlled by the cursor control device and the keyboard, wherein the KM switching device includes interface hosts coupled to each of the first set ports, a first HID (human interface device) device and a second HID (human interface device) device coupled to one of the second set ports, respectively, wherein the first HID device detects that the pointer controlled by the cursor control device moves out of the particular display boundary of the display screen to the other display screen, the host computer associated with the other display screen is controlled by the cursor control device and the keyboard through the associated interface host.

### BACKGROUND OF THE INVENTION

(a) Field of the Invention

The present invention relates to a system for controlling multiple computers, and more particularly, to a system for enabling a single user to control multiple computers and associated display screens by way of a single pointing device and keyboard combination without manual switching.

(b) Description of the Prior Art

There exist devices for interconnecting a single computer to multiple computers. For example, a keyboard/video/mouse (KVM) switch is a device that is generally connected to multiple computers in order to enable a single keyboard, video monitor and mouse to control each of the connected computers. In this way, a user may have access to multiple computers without having to invest in corresponding keyboards, monitors, and mice for each of the computers. When the user accesses a computer connected to the KVM switch, video signals are routed from the computer, processed, and displayed on the single video monitor.

When the user want to switch the output on the video monitor from presented computer to another, generally, the user must utilize pre-defined key sequences, such as <scroll-lock>, to release control over the present computer, return control to the KVM switch, and navigate through an on-screen menu or other display in order to access another computer connected to the KVM switch. In some cases, rather than utilizing key sequences and on-screen menus or displays in order to be able to access another computer, the user must physically actuate a button or other mechanism on the KVM switch. But requiring a user to physically access the KVM switch is adverse to the promotion of easy switching between computers, particularly if the KVM switch is placed in an inconvenient, remote, or inaccessible location, for example. Regardless of how access to a particular computer is granted, for typical KVM switches, only the video output of the accessed computer is processed and displayed on video monitor. That is, a user is not able to view the video output from the other “non-accessed” computers connected to the KVM switch because video output from the “accessed” computer covers the entire video display unit. Allowing a user to view and access one computer while also allowing the user to view the other “non-accessed” computers would not only provide greater information to the user, but would also provide the foundation for enabling quick and seamless navigation between all the computers.

U.S. Pat. No. 7,240,111, the contents of which are hereby incorporated by reference, discloses a KVM switching device for interconnecting a single user console having user interface devices to plurality of host computers. The KVM switching device manages the video signals transmitted from each of the plurality of host computers for simultaneously displaying video signals from at least two of the plurality of host computers on the user console video display unit. The KVM switching device includes a scaling module and a cropping module. The scaling module proportionally reduces the size of the host computer windows so that more than one host computer window may be visible at a given time. These scaled windows may be made larger or smaller according to the preference of the user. The cropping module removes portions of the host computer windows that cannot be seen due to any overlapping between windows.

However, for a user (ex., a security analyst) needing to monitor many computer windows speaking, displaying all the host computer windows on the user console video display unit will be scaled down the windows boundary due to the user difficult to monitor all the computer windows simultaneously.

Therefore, a keyboard/mouse (KM) switch is developed to connect to multiple computers in order to enable a single keyboard and mouse to control each of the connected computers and associated display screens simultaneously. Due to the each of the computers displays one host computer window on the video display unit, the computer window will not be scaled down and the user will be easy to monitor all the computer windows simultaneously.

However, as the KVM switch, the KM switch also needs pre-defined key sequences, such as <scroll-lock>, or switching buttons to release control over the present computer in order to access another computer connected to the KM switch.

It is desirable, therefore, to provide a switching system that has an intuitive user interface to allow for easy interaction with one or more computers connected to the switching system and allow for enabling a single user to control multiple computers and associated display screens by way of a single pointing device and keyboard combination without manual switching.

### SUMMARY OF THE INVENTION

It is an object of the present invention to enable a single user to control plurality of host computers and associated display screens by way of a single pointing device and keyboard combination without manual switching.

According to a preferred embodiment, the present invention provides a system for controlling multiple computers comprising a plurality of host computers with associated display screens with particular display boundaries, a set of a cursor control device and a keyboard and a KM (keyboard/mouse) switching device with second set ports coupled to each of the host computers and first set ports coupled to the cursor control device and the keyboard, wherein a pointer controlled by the cursor control device is located within one of the display screens with a particular display boundary and the host computer associated with the display screen is controlled by the cursor control device and the keyboard, wherein the KM switching device includes interface hosts coupled to each of the first set ports, a first HID (human interface device) device and a second HID (human interface device) device coupled to one of the second set ports, respectively, wherein the first HID device detects that the pointer controlled by the cursor control device moves out of the particular display boundary of the display screen to the other display screen, the host computer associated with the other display screen is controlled by the cursor control device and the keyboard through the associated interface host.

According to another embodiment, the present invention provides a system for controlling multiple computers comprising a plurality of host computers with associated display screens with particular display boundaries, a set of a cursor control device and a keyboard and a KM (keyboard/mouse) switching device with second set ports coupled to each of the host computers and first set ports coupled to the cursor control device and the keyboard, wherein a pointer controlled by the cursor control device is located within one of the display screens with a particular display boundary and the host computer associated with the display screen is controlled by the cursor control device and the keyboard, wherein the KM switching device includes an interface host connected to a hub coupled to each of the first set ports, a first HID (human interface device) device and a second HID (human interface device) device coupled to one of the second set ports, respectively, wherein the first HID device detects that the pointer controlled by the cursor control device moves out of the particular display boundary of the display screen to the other display screen, the host computer associated with the other display screen is controlled by the cursor control device and the keyboard through the associated interface host.

According to a further another embodiment, the present invention provides a method for controlling multiple computers comprising following steps: acquiring boundaries of display screens of a plurality host computers; initializing one of the host computers controlled by a cursor control device and a keyboard with a pointer controlled by the cursor control device displaying on the display screen associated with the host computer; detecting if the pointer controlled by the cursor control device moves out of the boundary of the display screen to the other display screen; and connecting the cursor control device and a keyboard to one of the host computers corresponding to the other display screen.

The details and technology of the present invention are described below with reference to the accompanying drawings:

### BRIEF DESCRIPTION OF THE DRAWINGS

FIG. 1 is a diagram showing an exemplary system according to the invention;

FIG. 2 is an inward appearance diagram of the keyboard mouse switching device according to the invention;

FIG. 3 is another inward appearance diagram of the keyboard mouse switching device according to the invention; and

FIG. 4 is a flowchart for operation according to the invention.

### DETAILED DESCRIPTION OF THE PREFERRED EMBODIMENTS

The present invention relates generally to a KM switching system for enabling a single user to control multiple computers and associated display screens by way of a single pointing device and keyboard combination without manual switching. The concept is used in the KM switching system of present invention.

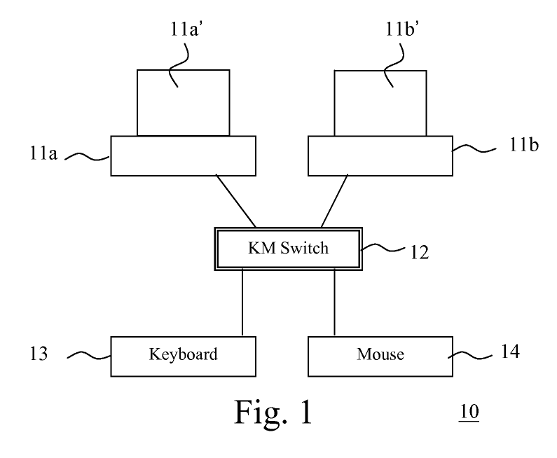

As shown in FIG. 1, the system 10 for controlling multiple computers comprising a plurality of host computers 11a-11b with associated display screens 11a′, 11b′ with particular display boundaries, a set of a cursor control device 14 and a keyboard 13 and a KM (keyboard/mouse) switching device 12. The pointer 14′ displaying on the display screen 11b′ means that the host computer 11b is controlled by the keyboard 13 and the cursor control device 14 through the KM switching device 12. If the pointer controlled by the cursor control device 14 moving left to the display screen 11a′, it means that the host computer 11a is controlled by the keyboard 13 and the cursor control device 14 through the KM switching device 12. Thus, users will be very convenient in controlling multiple computers and associated display screens by way of a single pointing device and keyboard combination without manual switching.

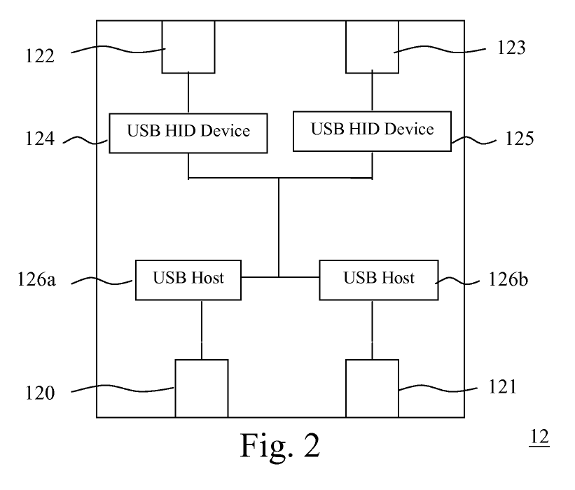

FIG. 2 is an inward appearance diagram of the keyboard mouse switching device according to the invention and also referring to FIG. 1, the KM (keyboard/mouse) switching device 12 has second set ports 122, 123 coupled to each of the host computers 11a, 11b and first set ports 120, 121 coupled to the cursor control device 14 and the keyboard 13. The pointer 14′ controlled by the cursor control device 14 is located within the display screen 11b′ with a particular display boundary and the host computer 11b associated with the display screen 11b′ is controlled by the cursor control device 14 and the keyboard 13. The KM switching device 12 includes interface hosts 126a, 126b each coupled to the corresponding first set ports 120, 121. The KM switching device 12 also includes a first HID (human interface device) device 124 and a second HID (human interface device) device 125 each coupled to the second set ports 122, 123, respectively. When the first HID device 124 detects that the pointer 14′ controlled by the cursor control device 14 moves out of the particular display boundary of the display screen 11a′ to the other display screen 11b′, the host computer 11b associated with the other display screen 11b′ is controlled by the cursor control device 14 and the keyboard 13 through the associated interface host 126b and the second HID device 125.

Users can monitor the display screen 11a′ and 11b′ simultaneously and easily and control the host computer 11a or 11b by controlling the movement of the cursor control 14 device through the path of interface host 126a or 126b with first HID device 124 or 125 without manual switching.

Most of the cursor control device and keyboards have USB connector or PS/2 connector. Therefore, the interface host 126a, 126b, the first HID device 124 and the second HID device 125 are supporting USB format or PS/2 standard.

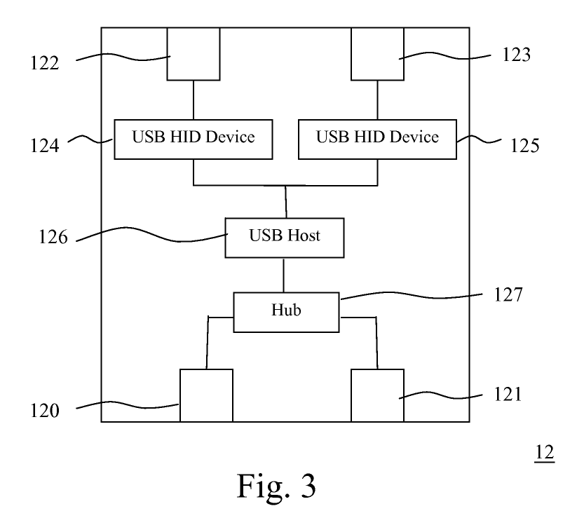

FIG. 3 is another inward appearance diagram of the keyboard mouse switching device according to the invention. The KM (keyboard/mouse) switching device 12 has second set ports 122, 123 coupled to each of the host computers 11a, 11b and first set ports 120, 121 coupled to the cursor control device 14 and the keyboard 13. The pointer 14′ controlled by the cursor control device 14 is located within the display screen 11b′ with a particular display boundary and the host computer 11b associated with the display screen 11b′ is controlled by the cursor control device 14 and the keyboard 13. The KM switching device 12 includes an interface host 126 connected to a hub 127 coupled to each of the first set ports. The KM switching device 12 also includes a first HID (human interface device) device 124 and a second HID (human interface device) device 125 each coupled to the second set ports 122, 123, respectively. When the first HID device 124 detects that the pointer 14′ controlled by the cursor control device 14 moves out of the particular display boundary of the display screen 11a′ to the other display screen 11b′, the host computer 11b associated with the other display screen 11b′ is controlled by the cursor control device 14 and the keyboard 13 through the associated interface host 125.

Users can monitor the display screen 11a′ and 11b′ simultaneously and easily and control the host computer 11a or 11b by controlling the movement of the cursor control 14 device through the path of interface host 126 with first HID device 124 or 125 without manual switching.

Most of the cursor control device and keyboards have USB connector or PS/2 connector. Therefore, the interface host 126, the first HID device 124 and the second HID device 125 are supporting USB format or PS/2 standard.

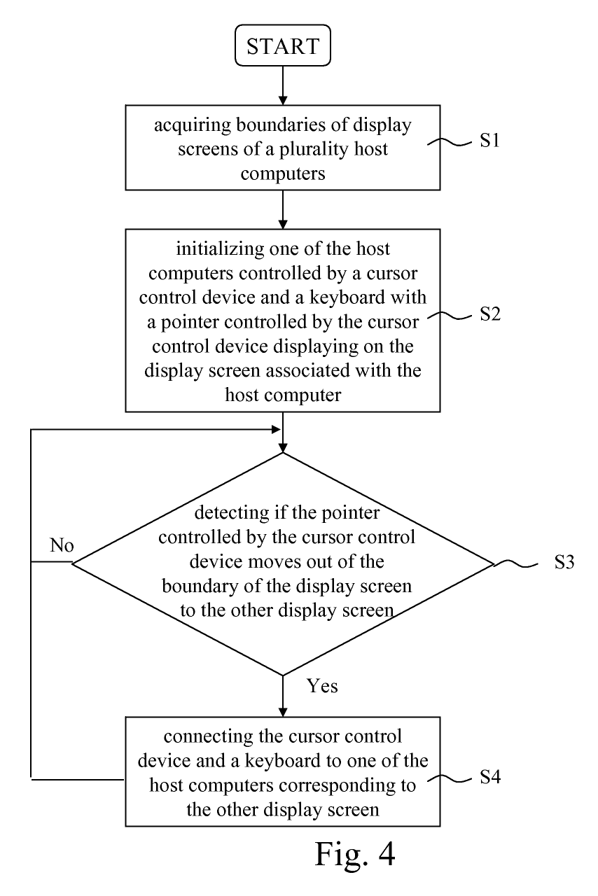

FIG. 4 is a flowchart for operation according to the invention. The method is used for controlling a plurality of computers by a keyboard and a cursor control device through a KM switching device without manual switching. The KM switching device acquires boundaries of display screens of a plurality host computers (S1), then initializes one of the host computers controlled by a cursor control device and a keyboard with a pointer controlled by the cursor control device displaying on the display screen associated with the host computer (S2). The KM switching device detects if the pointer controlled by the cursor control device moves out of the boundary of the display screen to the other display screen (S3). If the pointer is still moving in the boundary of the present display screen, the step S3 is repeated. If the pointer controlled by the cursor control device moves out of the boundary of the present display screen to the other display screen, the KM switching device connects the cursor control device and a keyboard to one of the host computers corresponding to the other display screen for controlling.

Moreover, the KM switching device includes a plurality of HID (human interface device) devices each connected to one of the host computers for calculate the each boundary of display screen of the corresponding host computer. When the pointer displayed on a particular display screen of the corresponding host computer, a user can access the corresponding host computer though the keyboard and cursor control device. After moving the pointer through the cursor control device to the other display screen, the host computer associated with the other display screen will be controlled by the cursor control device and the keyboard through the corresponding HID device.

The second set ports of the KM switching device of the present invention have more than 2 ports and the HID device of the KM switching device of the present invention have more than 2 sets for connecting more than 2 host computers. The first HID device and the second HID device are one of the embodiments.

Having thus described a preferred embodiment of an system that allows for the simultaneous monitoring of the display screens from a plurality of host computers and provides for easy access to and intuitive switching between those connected computers, it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

What is claimed is:

1. A system for controlling multiple computers comprising a plurality of host computers with associated display screens with particular display boundaries, a set of a cursor control device and a keyboard and a keyboard mouse switching device with second set ports coupled to each of the host computers and first set ports coupled to the cursor control device and the keyboard;
wherein a pointer controlled by the cursor control device is located within one of the display screens with a particular display boundary and the host computer associated with the display screen is controlled by the cursor control device and the keyboard;
wherein the keyboard mouse switching device includes interface hosts coupled to each of the first set ports, a first human interface device and a second human interface device coupled to one of the second set ports, respectively;
wherein the first human interface device detects that the pointer controlled by the cursor control device moves out of the particular display boundary of the display screen to the other display screen, the host computer associated with the other display screen is controlled by the cursor control device and the keyboard through the associated interface host.

2. The system as defined in claim 1, wherein the keyboard and the cursor control device have USB connectors and the interface hosts, the first human interface device and first human interface device are USB standard.

3. A system for controlling multiple computers comprising a plurality of host computers with associated display screens with particular display boundaries, a set of a cursor control device and a keyboard and a keyboard mouse switching device with second set ports coupled to each of the host computers and first set ports coupled to the cursor control device and the keyboard;
wherein a pointer controlled by the cursor control device is located within one of the display screens with a particular display boundary and the host computer associated with the display screen is controlled by the cursor control device and the keyboard;
wherein the keyboard mouse switching device includes an interface host connected to a hub coupled to each of the first set ports, a first human interface device and a second human interface device coupled to one of the second set ports, respectively;
wherein the first human interface device detects that the pointer controlled by the cursor control device moves out of the particular display boundary of the display screen to the other display screen, the host computer associated with the other display screen is controlled by the cursor control device and the keyboard through the associated interface host.

4. The system as defined in claim 3, wherein the keyboard and the cursor control device have USB connectors and the interface hosts, the first human interface device and first human interface device are USB standard.

5. A method for controlling multiple computers comprising the steps of:
acquiring boundaries of display screens of a plurality host computers;
initializing one of the host computers controlled by a cursor control device and a keyboard with a pointer controlled by the cursor control device displaying on the display screen associated with the host computer;
detecting if the pointer controlled by the cursor control device moves out of the boundary of the display screen to the other display screen; and
connecting the cursor control device and a keyboard to one of the host computers corresponding to the other display screen.
